(19) United States
(12) Patent Application Publication
(10) Pub. No.: US 2014/0281306 A1
(43) Pub. Date: Sep. 18, 2014

(54) METHOD AND APPARATUS OF NON-DISRUPTIVE STORAGE MIGRATION

(71) Applicant: HITACHI, LTD., Tokyo (JP)

(72) Inventors: Akio NAKAJIMA, Santa Clara, CA (US); Akira DEGUCHI, Santa Clara, CA (US)

(73) Assignee: HITACHI, LTD., Tokyo (JP)

(21) Appl. No.: 13/830,427

(22) Filed: Mar. 14, 2013

(51) Int. Cl. G06F 3/06

(52) U.S. Cl. CPC G06F 3/0647; G06F 3/0604; G06F 3/0683
USPC 711/162; 711/154

(57) ABSTRACT

Example implementations described herein are directed to non-disruptive I/O storage migration between different storage types. In example implementations, virtual volume migration techniques such as snapshot, thin-provisioning, tier-provisioning, de-duplicated virtual volume, and so forth, are conducted between different storage types by using pool address re-mapping. In example implementations, asynchronous remote copy volume migration is performed without the initial secondary volume copy.

### BACKGROUND

1. Field

Example implementations are generally related to computer systems, storage networking, and interface protocol and server/storage migration technology, and more specifically, to handling various protocols between storage systems made by different vendors.

2. Related Art

In the related art, there are storage systems produced by various vendors. However, operation of the migration of storage data can only be presently facilitated between storage systems made by the same vendor, so that the storage systems use the same technology and protocols to interface with each other.

Consider the example environment of a computer system as depicted in FIG. 1. If the storage types of the source storage 2a and the destination storage 2b are different (e.g., produced by different vendors, otherwise incompatible etc.), internal information of the storage systems cannot be communicated between the storage program of the source storage 2a and the storage program of the destination storage 2b due to issues such as incompatibility or use of different vendor technologies.

Storage migration can be adversely affected from utilizing storage systems from different vendors. When the application stops, the internal copy operation of the storage system may not be executable to perform migration operations to the other storage system. For example, conducting a remote copy operation during disaster recovery may be halted during the migration to the other storage system due to incompatibility or other issues.

### SUMMARY

Aspects of the present application may include a storage system, which may involve a plurality of storage devices; and a controller coupled to the plurality of storage devices. The controller may be configured to provide access to a virtual volume for a computer, the virtual volume being mapped to a logical volume of another storage system, for managing data stored in the logical volume by using the virtual volume; obtain path information of the another storage system, the path information comprising information identifying an active status of a first port of the another storage system targeted from the computer; modify the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and send the modified path information to the computer.

Aspects of the present application may further include a computer readable storage medium storing instructions for executing a process for a storage system. The instructions may include providing access to a virtual volume for a computer, the virtual volume being mapped to a logical volume of another storage system, for managing data stored in the logical volume by using the virtual volume; obtaining path information of the another storage system, the path information comprising information identifying an active status of a first port of the another storage system targeted from the computer; modifying the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and sending the modified path information to the computer.

Aspects of the present application may further include a method for a storage system, which may involve providing access to a virtual volume for a computer, the virtual volume being mapped to a logical volume of another storage system, for managing data stored in the logical volume by using the virtual volume; obtaining path information of the another storage system, the path information comprising information identifying an active status of a first port of the another storage system targeted from the computer; modifying the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and sending the modified path information to the computer.

### BRIEF DESCRIPTION OF THE DRAWINGS

FIG. 1 illustrates an example environment of computer system.

FIG. 2 illustrates a block diagram for a host server, in accordance with an example implementation.

FIG. 3 illustrates multipath information in table form, in accordance with an example implementation.

FIG. 4 illustrates a block diagram of a storage, in accordance with an example implementation.

FIG. 5 illustrates a block diagram for the memory of the storage, in accordance with an example implementation.

FIG. 6 illustrates the host multipath table, in accordance with an example implementation.

FIG. 7 illustrates the external device multipath table, in accordance with an example implementation.

FIG. 8 illustrates an external device table, in accordance with an example implementation.

FIG. 9 illustrates an internal device table, in accordance with an example implementation.

FIG. 10 describes an example of a multipath I/O path change flow.

FIG. 11 describes migration from a source storage to a destination storage, in accordance with an example implementation.

FIG. 12 describes an example ladder chart for migrating data from the source storage to the destination storage without coordinating with the storage program of the source storage, in accordance with an example implementation.

FIG. 13 illustrates a migration method for a thin provisioning volume, in accordance with an example implementation.

FIG. 14 illustrates a thin provisioning table, in accordance with an example implementation.

FIG. 15 illustrates an example flow chart for conducting thin provisioning volume migration, in accordance with an example implementation.

FIG. 16 illustrates a migration method for a snapshot volume or replication/backup volume, in accordance with an example implementation.

FIGS. 17a and 17b illustrate examples of the format for the physical block address or the pool block address information, in accordance with an example implementation.

FIG. 18 illustrates an example flow chart for the LBA/PBA mapped virtual volume migration, in accordance with an example implementation.

FIG. 19 illustrates an example of a snapshot table, in accordance with an example implementation.

FIG. 20 illustrates an example flow chart for a non-disruptive migration process of the primary volume and related snapshot volumes, in accordance with an example implementation.

FIG. 21 illustrates a migration method for a tier virtual volume, in accordance with an example implementation.

FIG. 22 illustrates an example of a tier virtual volume table, in accordance with an example implementation.

FIG. 23 illustrates an example flow chart for a non-disruptive migration process of the tier virtual volume, in accordance with an example implementation.

FIG. 24 illustrates a migration method for a data de-duplication volume, in accordance with an example implementation.

FIG. 25 illustrates an example of a de-duplication virtual volume table, in accordance with an example implementation.

FIG. 26 illustrates an example flow chart for non-disruptive I/O and data de-duplication volume migration configuration from other systems, in accordance with an example implementation.

FIG. 27 illustrates an example volume configuration of a cascading virtual volume (VVOL), source storage PBA space to local storage PBA space mapping, and pool volume mapping, in accordance with an example implementation.

FIG. 28 is example environment for the asynchronous remote copy configuration, in accordance with an example implementation.

FIG. 29 illustrates an example environment of non-disruptive I/O and asynchronous remote copy volume migration configuration from other systems, in accordance with an example implementation.

FIG. 30 illustrates an example flow chart for non-disruptive I/O and remote copy volume migration configuration from other systems, in accordance with an example implementation.

FIG. 31 illustrates an example environment of a non-disruptive I/O and synchronous remote copy volume migration configuration from other systems, in accordance with an example implementation.

FIG. 32 illustrates an example flow chart for changing the configuration of the volume ID, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. The implementations described herein are also not intended to be limiting, and can be implemented in various ways, depending on the desired implementation.

FIG. 1 illustrates an example environment of computer system. The environment may include host server 1, source storage 2a, destination storage 2b, and management client 7. The host server 1 may include multipath software 12 which communicates with the source storage 2a. The source storage 2a may include volume 21a which is accessible by the host server 1. The destination storage 2b mounts a volume (VOL) 21a of source storage 2a to virtual volume (V-VOL) 21b to migrate the volume 21a data to the destination storage 2b by using the external storage mount path 6.

When the storage types of the source storage 2a and the destination storage 2b are different (e.g., made by different vendors, otherwise incompatible, etc.), the storage program of source storage 2a and the destination storage 2b may not be capable of communicating internal information of the respective storages to each other. For example, the host server 1 may detect the path 4 of source storage 2a, but may not detect path 5 of the destination storage 2b if the storage program of destination storage 2b does not communicate the path information correctly to source storage 2a due to incompatibility.

FIG. 2 illustrates a block diagram for a host server, in accordance with an example implementation. The host server 1 may include a memory 10, a Central Processing Unit (CPU) 15 and a Small Computer Systems Interface (SCSI) initiator port 16.

The host server memory 10 may contain an application program 11, a multipath program 12, a multipath information 13, and a SCSI driver 14. The memory 10 may be in a form of a computer readable storage medium, which includes tangible media such as flash memory, random access memory (RAM), HDD, or the like. Alternatively, a computer readable signal medium can be used instead of a memory 10, which can be in the form of non-tangible media such as carrier waves. The memory 10 and the CPU 15 may work in tandem to function as a host controller for the host server 1.

FIG. 3 illustrates multipath information in table form, in accordance with an example implementation. The multipath information has two tables, search list 31 and path table 32. The search list 31 may include vendor ID and product ID field 33.

Each volume has a unique volume ID which may include SCSI vital product data (VPD) information. The volume ID of the VPD information may include the vendor ID and the product ID associated with the volume ID. The multipath software 12 facilitates the multipath operations when the vendor ID and the product ID associated with the volume ID is matched with the vendor ID and the product ID in the search list 31.

The path table 32 contains the vendor ID and the product ID associated with the volume ID field 34, the volume ID field 35, the relative port ID field 36 and asynchronous access state field 37.

SCSI VPD information may include information such as world wide unique volume ID and vendor ID, product ID, and so on. When two SCSI VPD information match in the search list 31 and two SCSI VPDs are the same volume ID, the multipath software 12 registers these two paths to work the multipath. When SCSI VPD information does not match the corresponding entry in the search list 31, the multipath software 12 does not register the path table 32.

FIG. 4 illustrates a block diagram of a storage, in accordance with an example implementation. The storage 2 may include SCSI port 41, CPU 42, Memory 43, SCSI initiator port 44, and storage media such as Serial Advanced Technology Attachment (SATA) Hard Disk Drive (HDD) 45, Serial Attached SCSI (SAS) HDD 46, Solid State Drive (SSD) 47, and Peripheral Computer Interface (PCI) bus attached flash memory 48. The memory 43 may be in a form of a computer readable storage medium, which includes tangible media such as flash memory, random access memory (RAM), HDD, or the like. Alternatively, a computer readable signal medium can be used instead of a memory 43, which can be in the form of non-tangible media such as carrier waves. The memory 43 and the CPU 42 may work in tandem to function as a storage controller for storage 2.

FIG. 5 illustrates a block diagram for the memory 43 of the storage 2, in accordance with an example implementation. The memory 43 may include storage program 50, the host multipath table 60, external device multipath table 70, external device table 80, internal device table 90, thin provisioning table 140, snapshot table 190, remote copy table 220, de-duplication volume table 250, and local copy or remote copy table 290. Further detail of each of these elements is provided below.

FIG. 6 illustrates the Host multipath table 60, in accordance with an example implementation. The Host multipath table 60 may include internal Logical Unit numbers (LUN) 61, storage target port world wide port name (WWPN) 62, and Multipath State 63. The multipath information, such as the Target Port Group descriptor, may be defined from the T10 SCSI Primary command set (SPC). When the storage program changes the multipath of host 1 to the paths of storage 2, the storage program changes the multipath state 63 and notifies the host. When the host multipath program 12 receives the notification, the host multipath program 12 changes the active path from which the host issues I/O commands.

FIG. 7 illustrates the external device multipath table 70, in accordance with an example implementation. The table 70 may include an internal Logical Unit Number (LUN) field 71, an external LUN field 72, an External Target WWPN field 73 and an external storage multipath state field 74. The external LUN field 71 is V-VOL mapping information of the external LU to the destination storage 2b via the external storage mount path 6.

The internal LUN field 72 contains mapping information of external LU that mounts from the external storage via external storage mount path 6. The external target WWPN field 73 contains target port information of the external storage (source storage 2a) to mount the external storage (source storage 2a). The external storage multipath state field 74 is the multipath state information that the destination storage 2b obtains from the external storage port (source storage 2a).

The following example process illustrates how takeover path operations can be conducted without coordinating with source storage 2a, in accordance with an example implementation. When the administrator establishes a connection between the external storage (source storage 2a) and the destination storage 2b via mount path 6, the storage program of the destination storage 2b overrides the source storage multipath information. The storage program of destination storage 2b provides the overridden multipath information to the host multipath program. The host multipath program 12 issues I/O from the source storage path to the destination storage path.

FIG. 8 illustrates an external device table 80, in accordance with an example implementation. The table 80 may include external LUN 81, SCSI Protocol Capability 82, and External Storage Function Type 83. If the destination storage obtains SCSI capability, then the function type for the migration volume may not be required. If the destination storage does not obtain SCSI capability from the source storage, then the function type or pair of volumes group may need to be setup for migration volumes.

FIG. 9 illustrates an internal device table 90, in accordance with an example implementation. The table 90 may include internal LUN 91, external LUN 92, Storage Function Type 93, and migration pair information 94. This table maps the information between the internal LUN and the external LUN of the source storage. To migrate multiple volumes, the migration pair is configured, then the destination storage migrates all of the migration pair volumes together. For example, a pair of snapshot volumes and the primary volume can be migrated all together.

FIG. 10 describes an example of a multipath I/O path change flow. The flow is initiated storage target port driven. The storage 2 has multipath state information 51 and target ports A 102 and B 103, wherein paths are initiated to the target ports by host port 111.

In a related art implementation, when the storage 2 notifies the host server 1 of a state change, the host server 1 issues SCSI commands, such as the “Report Target Port Group” SCSI command, to get multipath state information 51, such as the Target Port Group descriptor. The Target Port Group descriptor has a port offset identifier and an asynchronous access state (AAS). The “Report Target Port Group” SCSI command and Target Port Group descriptor are also defined from T10 SPC.

Then, the multipath program 12 of the host server 1 updates the multipath state information from the before state table 104 to the after state table 105. The multipath program 12 then changes the I/O path from path 4 to path 5, since the storage program changes multipath state information from the state of “path 4 is active, path 5 is offline” to the state of “path 4 is offline, path 5 is active”.

FIG. 11 describes migration from a source storage to a destination storage, in accordance with an example implementation. The flow is initiated destination storage target port driven. The following flow is an example of conducting a takeover path operation without coordinating with source storage 2a.

The source storage 2a and destination storage 2b has multipath state information 51 as illustrated from FIG. 10. When the administrator establishes a connection between the external storage (source storage 2a) and the destination storage 2b via mount path 6 from destination storage port 115 to target port 114, the storage program of the destination storage 2b obtains multipath information 118 from the source storage. The storage program of the destination storage 2b overrides the source storage multipath information 118. Then, the storage program of the destination storage 2b provides a notification to change the multipath state, and overrides the multipath information 51 of the destination storage for the host multipath program.

Host multipath program 12 changes the issuance of I/O commands from the target port 112 via the source storage path 4 to target port 113 via the destination storage path 5, since the storage program of the destination storage 2b changes the multipath state information 51 from the state information 118 “path 4 is active, path 6 is active” to the state information 119 “path 4 is offline, path 5 is active”.

The multipath program 12 of host server 1 does not utilize the path 6 state. The host multipath program 12 does not access the path 6 directory, since the target port 2 is not connected to the host server 1. So, the storage program of the destination storage 2b does not need the multipath state for path 6. The storage program of the destination storage 2b creates multipath information 51 of the destination storage to include or exclude path entry for path 6 for target port 2.

FIG. 12 describes an example ladder chart for migrating data from the source storage to the destination storage without coordinating with the storage program of the source storage, in accordance with an example implementation. In an example implementation, the destination storage program overrides the multipath state of the source storage, to facilitate compatibility for the migration.

At S1201, the host server 1 issues I/O commands from the host initiator port to the target port of the source storage 2a. At S1202, when the administrator establishes connections with migration mount path 6, then the destination storage 2b performs a storage migration operation. First, the destination storage obtains multipath state information from the source storage, via migration mount path 6 between the initiating port 115 of the destination storage 2b and the target port 114 of the source storage 2a. The storage program of the destination storage also obtains the migration volume identification and mounts the source volume to the virtual volume.

At S1203, the storage program of the destination storage 2b modifies the multipath state information from the source storage. The storage program of the destination storage 2b changes the path 4 state from active to offline, and adds the path 5 entry with an active state. The storage program of the destination storage 2b provides a notification of the state change to the host server using path 5 between the initiator port 111 of the host server 1 and the target port 113 of the destination storage 2b.

At S1204, the multipath program of the host server 1 detects the notification of the multipath state change of the source storage due to the destination storage event notification, wherein the multipath program of the host server 1 updates the path table 32 of the host multipath information 13. When the host server issue the next I/O, the host server changes the I/O issue path from path 4 to path 6, since the destination storages the update multipath state information of the source storage. The path 4 state is changed to the offline state and the path 6 state is added with an active state. The source storage is thereby not involved in the operation for changing the multipath state information of the source storage by the destination storage.

At S1205, the host server 1 issues I/O commands to the destination storage, since the host multipath program of the host server 1 has already updated the path table at S1204. At S1206, the storage program of the destination storage 2b reroutes received I/O commands of S1205 to the source storage via path 5. At S1207, the storage program of the destination storage 2b starts to migrate volume data from the source storage 2a to the destination storage 2b. At S1208, when the destination storage 2b completes the migration of volume data from the source storage, then the storage program of the destination storage 2b stops to reroute the received host I/O commands to the source storage. The migration flow can thereby be conducted without communicating to the storage program of the source storage 2a.

In the following example implementations, the destination storage obtains Logical Block Address (LBA) to Pool Block Address (PBA) mapping information by using sense data.

FIG. 13 illustrates a migration method for a thin provisioning volume, in accordance with an example implementation. To migrate the thin provisioning volume, the destination storage obtains the LBA status information by using the SCSI Get LBA Status command. When the destination storage obtains the LBA status information from the source storage, then the source storage returns information regarding whether logical block 133 is allocated/not allocated physical blocks. When the source storage returns the LBA status information indicating that these logical blocks are not allocated physical blocks in the pool volume, then the destination storage 2b does not allocate logical blocks to the physical block in the pool volume of the destination volume. The size of segment 135a of the source thin volume 131a may be a different size for the destination thin volume 131b, so the destination storage adjusts the segment size to migrate the thin volume.

FIG. 14 illustrates a thin provisioning table 140, in accordance with an example implementation. The table 140 contains allocation information indicating block addresses in the internal thin provisioning volume that are mapped to physical block addresses of a pool volume. The table 140 may contain internal volume id of thin volume (thin volume LUN) 141, pool volume id (Pool LUN) 142, and an anchor/de-allocated state bitmap of each segment 143. The thin provisioning segment size may be a different size for the source storage since the storage administrator may set different segment sizes for the source and destination storages. For the SCSI specification, such as the SCSI Get LBA Status command, the table 140 can be used to return allocation information for thin provisioning volume.

For example, when a logical block of a thin volume is not an allocated physical block, then the SCSI Get LBA Status command returns a “de-allocated” status. When a logical block of a thin volume is allocated a specific physical block of a specific pool volume, then the SCSI Get LBA Status command returns an “anchor” status.

FIG. 15 illustrates an example flow chart 1500 for conducting thin provisioning volume migration, in accordance with an example implementation. Firstly, the destination storage prepares to migrate the thin volume, as described in the flow diagram of FIG. 12. At S1501, to migrate the thin provisioning volume, the destination storage obtains the LBA status information using the SCSI Get LBA Status command. When the destination storage obtains the LBA status information from source storage, then the source storage returns information regarding whether the logical block 133 is allocated/not allocated physical blocks. The destination storage calculates the required capacity for the pool volume. If there is insufficient capacity, then the thin volume migration is indicated as failed.

At S1502, when the source storage returns LBA status information indicating that the logical blocks are not allocated physical blocks in the pool volume (NO), then the flow proceeds to S1505, otherwise (YES), the flow proceeds to S1503.

At S1503, the destination storage 2b calculates the segment allocation to adjust for the different segment sizes between the source storage and the destination storage, by using the anchored LBA range of Get LBA status information. If the destination segment size is smaller than the segment size of the source thin volume, the destination storage allocates multiple segments mapped to the pool volume to exceed the source segment size. At S1504, the destination storage 2b allocates LBA space from the destination thin volume mapped to the segments of the destination pool volume. Then, the destination storage 2b migrates data segments from the source thin volume. If the destination segment size is larger than the segment size of the source thin volume, then the destination storage pads the residual area of the segment by utilizing zero fill data or fixed pattern data. If the destination segment size is smaller than the source thin volume and the source data includes zero data or pattern data, the destination storage de-allocates specific segments mapped to the pattern data to de-allocate the destination segment.

At S1505, the destination storage 2b does not allocate logical blocks to the physical block in the pool volume of destination volume, and then proceeds to S1506.

At S1506, the destination storage 2b increments the LBA to issue the next Get LBA Status information for the source volume. At S1507, if the LBA is the Last LBA of the source volume of the source storage, then the flow ends. Otherwise, the flow proceeds to S1501 to continue the thin volume migration process.

The migration flow perform without communicating to the storage program or storage internal information of the source storage 2a (for example internal memory information is vendor specific).

FIG. 16 illustrates a migration method for a snapshot volume or replication/backup volume, in accordance with an example implementation. To migrate the primary snapshot volume and the pair of snapshot volumes related to the primary snapshot volume, the destination storage obtains LBA mapping information by using SCSI sense data or the Get LBA to PBA mapping information command to prevent the migration of non-updated segments, and to reduce the migration traffic between the source storage and the destination storage.

A segment of a snapshot volume 161aa, 161bb is a pointed segment of a pool volume 169a, 169b. A segment of another snapshot volume 161a, 161b is a pointed segment of a primary volume 168a, 168b. For example, when the new write data is received to the primary volume 168a, then the storage program copies the old data segment of the primary volume which associates the LBA of the write command to the latest snapshot volume 161aa, and saves to store old data to the snapshot pool volume 169a. Then the storage program updates the new data to the segment of the primary volume 168a.

When a segment of the primary snapshot volume is not updated, the segments of all of the snapshot volume related to the primary snapshot volume are mapped to the segments of the primary snapshot volume. The snapshot segment size may be different because the source storage and the destination storage may not necessarily utilize the same storage program. When the destination storage receives I/O from the host 1, then the destination storage 2b writes to the primary volume 168b of the destination storage 2b and the primary volume 168a of the source storage synchronously, which allows for recovery if the migration process of the destination storage fails due to a failure of the destination storage (e.g., goes down). The synchronous write further allows for the recovery process to recover the set of primary volume and related snapshot volumes.

FIGS. 17a and 17b illustrate examples of the format for the physical block address or the pool block address information 170, in accordance with an example implementation. FIG. 17a illustrates the returned sense data 170a with the SCSI Response. The SCSI Response for the result of the read command may include the Physical (or Pool) addresses descriptor format 170a. FIG. 17b illustrates the returned SCSI read data buffer with the new command such as the “Get Physical (Pool) Block Address” SCSI command. The SCSI Data for the data buffer of the Get PBA command may include the PBA descriptor format 170b. The formats 170a and 170b also may contain a number of descriptors field 171, and a list of Physical or Primary snapshot or Pool Block Address (PBA) descriptor format 172.

A PBA descriptor format 172 may include a LBA field 173 which maps the LBA to the internal PBA of the Pool LUN, the internal Physical or Pool LU Number field 174 which identifies the physical location of the Pool Volume, the Pool or Primary Block address field 175 which identifies the pool or primary block address of the physical volume or Pool Volume, and the segment size or length size 176 field. The formats provides mapping information indicating which LBA segment of snapshot virtual volume is located to the primary block address of the primary snapshot volume or the new data segment of the snapshot volume. The formats further provide mapping information indicating which LBA segment of the tier virtual volume is mapped to the pool block address of the pool volume. The formats further provide mapping information indicating which LBA segment of the de-duplication virtual volume is mapped to the pool block address of pool volume. The formats also provide mapping information indicating which LBA segment of backup volume, replication volume, resilience virtual volume (for example virtual volume to copy triplication to some physical volumes) is mapped to the pool block addresses of pool volumes. These volume types are called LBA/PBA mapped virtual volumes.

FIG. 18 illustrates an example flow chart 180 for the LBA/PBA mapped virtual volume migration, in accordance with an example implementation. In a first example, the destination storage issues an I/O command and a return SCSI response with PBA information is returned. At S1801, the destination storage issues an I/O read or write command to the source storage. At S1802, the source storage sends write data and updates the LBA/PBA mapping. The source storage receives the read data. At S1803, the source storage returns the SCSI completed response with PBA sense data 170a corresponding to the I/O read or write command.

In a second example, the destination storage issues a specific command to read PBA information. At S1804, the destination storage sends the Get PBA command to the source storage. At S1805, the source storage sends the data buffer PBA descriptor 170b. At S1806, the source storage returns the SCSI good response corresponding to the Get PBA command.

FIG. 19 illustrates an example of a snapshot table 190, in accordance with an example implementation. The table 190 contains the internal volume ID of the snapshot volume field 191, and the snapshot old data save list 193. The list 193 may contain a mapping of the snapshot pool or Primary Volume ID (Pool LUN) 195, the internal LBA of snapshot volume 196 and the pool block address (PBA) 197. When the primary volume receives write data, the storage program allocate storage area from the snapshot pool, and update the save list 193 of the latest snapshot volume. The storage program then stores the old data segment to the latest snapshot volume, and stores received write data to the primary volume.

When the host accesses I/O to a snapshot volume, the storage program then searches the snapshot old data save list 193 of the snapshot volume. If the LBA of the I/O is found in the snapshot old data save list 193, then the saved old data mapped to pool block address of the snapshot pool ID is returned. If the LBA of the I/O is not found in the snapshot old data save list 193, then the saved old data mapped to the pool block address of next new snapshot pool ID is returned. If the LBA of the I/O is not found in the snapshot old data save list 193, then the LBA is not updated, so the storage program accesses the primary volume.

FIG. 20 illustrates an example flow chart 2000 for a non-disruptive migration process of the primary volume and related snapshot volumes, in accordance with an example implementation. The administrator establishes a connection between the destination storage and the source storage, and between the destination storage and the host server. At S2001, the destination storage mounts the primary volume and the snapshot volume from the source storage. At S2002, the destination storage starts recording the update progress bitmap for the new update data from the host server of the primary volume and the snapshot volumes of the destination storage, or completes the migration of data from the source storage, to reduce data transfer from the source storage. At S2003, the destination storage obtains the LBA/PBA mapping information for the primary volume by using the Get PBA SCSI command.

At S2004, the destination storage obtains the LBA/PBA mapping information for the first snapshot volume by using the Get PBA SCSI command. The destination storage constructs an internal snapshot table and calculates the required capacity of pool volume. If there is insufficient capacity from the pool volume of the destination storage, then the migration fails. At S2005, the next snapshot volume is considered. At S2006, a check is performed to determine if the snapshot volume is the last snapshot volume to be checked. If NO, then the flow proceeds to S2004. If YES, then the flow proceeds to S2007.

At S2007, the destination storage prepares to migrate the primary volume and related snapshot volumes, as described in the flow diagram of FIG. 12. At S2008, the destination storage migrates the data from the primary volume and the snapshot volumes of the source storage (e.g., in its entirety). Then, the destination storage migrates each of the snapshot volumes from the source storage. To reduce redundantly transferring data, the destination storage migrates the data segments mapped to the pool volume from the source storage by using the snapshot table.

At S2009, when the destination storage receives the host read I/O command before the data segment is migrated from the source storage, and destination storage has not yet received the data segment, then the destination storage reads the data segment from the source storage. Then, the destination storage update progress bitmap of destination storage. At S2010, when the destination storage receives host write I/O command, then the destination storage write both primary volume of source storage and destination storage respectively, then destination storage updates migration progress bitmap. At S2011, when the destination storage checks the migration bitmap, then the specific segment is updated (set bit), and the destination storage does not migrate data from the source storage and proceeds to the next data segment instead. At S2012, the destination storage checks for the migration of all data segments of the primary volume and the snapshot volumes. If the migration is not completed (NO), then the flow proceeds to process the next data segment of the primary volume and the related snapshot volumes, and proceeds to S2008. If migration is complete (YES), then the flow ends.

If the snapshot segment size of the source storage is different from the destination storage, then the destination storage allocates multiple segments or a single segment and updates the snapshot table for padding over or shortening data segments of the destination storage. This process is similar to the one described for the thin volume migration of FIG. 15.

In the migration process, when the destination storage obtains the LBA and pool block address (PBA) mapping, the destination storage can thereby reduce the transfer of redundant data mapped to the same segment of the primary volume or the snapshot pool volume.

FIG. 21 illustrates a migration method for a tier virtual volume, in accordance with an example implementation. In an example implementation, a segment of the tier virtual volume 212a, 212b is mapped to a specific tier pool from multiple tier pools. To migrate the tier virtual volume, the destination storage obtains the tier information by using the SCSI “LBA Access Hints” command. The command retrieves information about tier media information related LBA segments. The destination storage sends the LBA access hint command to the tier virtual volume of the source storage, wherein the destination storage returns the tier information related to the LBA segment of the tier virtual volume of the source storage. The destination storage constructs a tier table and migrates pool data to the specific tier pool.

FIG. 22 illustrates an example of a tier virtual volume table, in accordance with an example implementation. The table 220 may contain the internal volume ID of the tier virtual volume field 221, and tier mapping table 222. The tier mapping table 222 may contain a mapping of the internal LBA of the snapshot volume field 225, the tier pool ID (Pool LUN) field 226, the pool block address (PBA) 227, and hint information 228. Hint information may contain access pattern information such as random I/O, sequential I/O, read I/O, write I/O, read write mix I/O, higher priority area, and lower access area.

When the host updates the LBA access hint, then the storage program updates the hint field. The storage program then searches for specific media based on the access pattern hint information, and allocates segment from the tier pool. The storage program then migrates the segment of the current tier pool to the specific tier pool which is selected based on the access hint information. Then the storage program deletes the current tier data.

FIG. 23 illustrates an example flow chart 2300 for a non-disruptive migration process of the tier virtual volume, in accordance with an example implementation. The administrator establishes connections between the destination storage and the source storage, and between the destination storage and the host server.

At S2301, the destination storage mounts the tier virtual volume from the source storage. At S2302, the destination storage starts recording the update progress bitmap for the new update data from the host server of the tier virtual volume of the destination storage, or completes the migration of data from the source storage, to reduce the data transfer from the source storage. At S2303, the destination storage obtains LBA/PBA mapping information for the tier virtual volume by using the Get PBA SCSI command from the source storage, or the destination storage obtains the segment information by using the LBA access hint command from the source storage. Then the destination storage constructs a tier mapping table related to the pool id classification, since other tier virtual volumes of the destination storage are using segments with a PBA address and the PBA address of the tier pool of the destination storage may conflict with the mapped information PBA address related to the tier virtual volume of the source storage. At S2304, the destination storage calculates each required capacity of the tier pool volumes. If higher performance tier pool of destination storage is required and there is insufficient capacity (NO), then the destination storage sends a notification regarding possible performance degradation and to add more storage tier capacity, and the migration fails. If the tier pool has insufficient capacity, but another tier contains sufficient capacity with substantially no adverse effects to performance, then the destination storage remaps the tier pool and constructs the tier mapping table of the tier virtual volume.

At S2305, the destination storage prepares to migrate the path information related to the tier virtual volumes, as described in the flowchart of FIG. 12. At S2306, the destination storage migrates the data of the tier virtual volume from the source storage. At S2307, when the destination storage receives the host read I/O command before the data segment is migrated from the source storage, and the destination storage has not yet received the data segment, then the destination storage reads the data segment from the source storage. The destination storage updates the progress bitmap of the destination storage. At S2308, when the destination storage receives the host write I/O command, then the destination storage writes to both the primary volume of the source storage and the destination storage respectively. Then, the destination storage updates the migration progress bitmap. At S2309, when the destination storage checks the migration bitmap, the specific segment is updated (set bit). Then, the destination storage does not migrate data from the source storage and instead, proceeds to the next data segment. At S2310, the destination storage checks if all data segments of the tier virtual volumes are migrated. If not (NO), then the flow proceeds to process the next data segment of the tier virtual volume and proceeds to S2306. If migration of the segments are completed (YES), then the flow ends.

When the destination storage obtains the LBA access hint information, the destination storage constructs tier pool mapping between the LBA of the tier virtual volume and the PBA of each of the pool volumes, although each tier pool capacity may not be the same, and/or other tier virtual volumes may be allocated, thereby having conflicting PBA address for migration.

FIG. 24 illustrates a migration method for a data de-duplication volume, in accordance with an example implementation. Each of the storages has hash function to calculate a hash key of a data segment to check same or different fingerprint of data segment. Because each hash function of the source storage and the destination storage are different, the destination storage needs to recalculate the hash key table to migrate the data de-duplication volume from the source storage. To migrate the data de-duplication volume 241a, 242a to 241b, 242b, as well as pool data related to the de-duplication volume (e.g. from pool volume 249a to 249b), the destination storage obtains LBA mapping information by using SCSI sense data or the Get LBA to PBA mapping information command, to prevent the migration of non-updated segments and to reduce the migration traffic between the source storage and the destination storage.

FIG. 25 illustrates an example of a de-duplication virtual volume table 250, in accordance with an example implementation. The table 250 may contain the internal volume ID of the de-duplication virtual volume field 251, the de-duplication pool ID (Pool LUN) 252, and the de-duplication data store list 253. The list 253 contains a mapping of the internal LBA of the de-duplication virtual volume 255, the pool block address (PBA) 256, and a hash value 257. The list may contain two types of tables; the LBA sorted table and the hash value sorted table.

When the de-duplication virtual volume receives write data, the storage program calculates the hash value and searches the list 253. If the hash value is found and the data is determined to be the same, then the storage program updates the list 253 and does not store the write data. If the data is not the same, then the storage program allocates store area from the de-duplication pool, and updates list 253 and stores the write data.

When each de-duplication virtual volume is mapped to the same de-duplication pool, then the de-duplication hash table based on the list 253 is shared with each de-duplication virtual volume. So each de-duplication virtual volume writes the same data, and the de-duplication pool allocates only one segment.

When migration is conducted for the de-duplication virtual volume from the source storage, the destination storage gets the PBA mapping information from using the process described in FIG. 18, and re-constructs the hash value, since the hash calculation algorithm between the source storage and the destination storage may be different. The PBA address may be used by other virtual volumes for allocation, so the destination storage re-constructs the remapping of de-duplication virtual volume table.

The flow can be implemented similarly to the flow described above for the snapshot and the tier virtual volume.

FIG. 26 illustrates an example flow chart 2600 for non-disruptive I/O and data de-duplication volume migration configuration from other systems, in accordance with an example implementation.

At S2601, the destination storage mounts the data de-duplication virtual volume from the source storage. At S2602, the destination storage starts recording the update progress bitmap for the new update data from the host server of the data de-duplication virtual volume of the destination storage, or completes the migration of data from the source storage, to reduce the data transfer from the source storage. At S2603, the destination storage obtains LBA/PBA mapping information for the data de-duplication virtual volume by using the Get PBA SCSI command from the source storage. Then the destination storage constructs a data de-duplication mapping table related to the pool id classification, since other data de-duplication virtual volumes of the destination storage are using segments with a PBA address and the PBA address of the tier pool of the destination storage may conflict with the mapped information PBA address related to the data de-duplication virtual volume of the source storage. At S2604, the destination storage prepares to migrate the path information related to the tier virtual volumes, as described in the flowchart of FIG. 12.

At S2605, the destination storage migrates the data of the data de-duplication virtual volume from the source storage. At S2606, when the migrated data is at a new pool address, then the destination storage calculates the fingerprint hash value, constructs a new entry for the de-duplication data store list 253, and allocates new data store to pool volume 249b. At S2607, if the migrated data is at an existing pool address in the pool volume 249b of destination storage 2b, then the destination storage does not calculate fingerprint hash value since the migrated data is the same existing data of pool volume 249b. The destination storage updates de-duplication data store list 253 to point migrated data to the existing data stored in pool volume 249b.

At S2608, when the destination storage receives the host write I/O command, then the destination storage writes to both the primary volume of the source storage and the destination storage respectively. Then, the destination storage updates the migration progress bitmap. When the destination storage checks the migration bitmap, the specific segment is updated (set bit). Then, the destination storage does not migrate data from the source storage and instead, proceeds to the next data segment. At S2609, when the destination storage receives the new host write I/O data and the data is duplicated data in the destination pool volume, the destination storage calculates the fingerprint of the host write data for data comparison, and updates the existing entry of the de-duplication data store list 253 to point to the existing duplicated data of pool volume 249b of the destination storage. At S2610, the destination storage checks if all data segments of the data de-duplication virtual volumes are migrated. If not (NO), then the flow proceeds to process the next data segment of the data de-duplication virtual volume and proceeds to S2605. If all of the migration of the segments are completed (YES), then the flow ends.

FIG. 27 illustrates an example volume configuration of a cascading virtual volume (VVOL), source storage PBA space to local storage PBA space mapping, and pool volume mapping, in accordance with an example implementation. When the destination storage obtains PBA/LBA mapping information from the source storage, the destination storage re-maps the local PBA address space. Then, the destination storage can migrate a whole type volume such as the thick volume (flat space physical volume), thin virtual volume, snapshot volume, de-duplication volume, local copy volume, tier volume, and so forth. A segment of these volumes is mapped to the PBA pool (physical) volume.

In the following example implementations, asynchronous remote copy migration is performed to migrate both P-VOL and S-VOL together.

FIG. 28 is example environment for the asynchronous remote copy configuration, in accordance with an example implementation. The example illustrated in FIG. 28 is an asynchronous remote copy. The following description and implementation is similar to the synchronous remote copy.

FIG. 29 illustrates an example environment of non-disruptive I/O and asynchronous remote copy volume migration configuration from other systems, in accordance with an example implementation. To migration the primary volume (P-VOL) and the secondary volume (S-VOL) without an initial copy of S-VOL, the environment may undergo a flow as disclosed in FIG. 30.

FIG. 30 illustrates an example flow chart 2900 for non-disruptive I/O and remote copy volume migration configuration from other systems, in accordance with an example implementation. The administrator establishes connections between the destination storage and the source storage, and between the destination storage and the host server in each site and for the remote copy port configuration.

At S3001, a setup is prepared so that the destination primary storage mounts the P-VOL of source primary storage. At S3002, the destination primary storage starts recording the update progress bitmap for the new update data from the host server of the primary volume of the destination primary storage, to use the resync data to the secondary volume of the destination secondary storage (see S3008 to S3012). At S3003, the destination primary storage prepares to migrate the primary volume as described in the flow for FIG. 12. At S3004, a setup is prepared so that the source primary storage suspends remote copy operations. The source storage stops to queue sending data to the secondary volume of source secondary storage.

At S3005, when the destination primary storage receives the host write I/O command, the destination storage writes to both the primary volume of the source primary storage and the primary volume of destination primary storage. The destination storage records the bitmap of the primary volume of the destination primary storage. At S3006, a check is performed for the completion of the suspension of the source primary storage. If the suspension is not completed (NO), then the destination primary storage proceeds to S3005. If the suspension is complete (YES), then the flow proceeds to S3007.

At S3007, a setup is performed so that the destination secondary storage mounts the S-VOL of the source secondary storage. At S3008, a setup is performed so that the destination primary storage starts the remote copy operation. The destination primary storage starts to resync the differential data of the primary volume of the destination primary storage, by using the bitmap of the primary volume of the destination primary volume to the S-VOL of the destination secondary storage which mounts from the source secondary storage. At S3009, the destination primary storage migrates data to the P-VOL of the destination primary storage from the source primary storage. The destination secondary storage migrates data to the S-VOL from the source secondary storage.

At S3010, when the destination primary storage receives the host write I/O, the destination storage writes to both the primary volume of the source primary storage and the primary volume of the destination primary storage. The destination storage also records the bitmap of the primary volume of the destination primary storage. At S3011, when the destination primary storage updates the bitmap, then the destination primary storage sends the differential data based on the bitmap.

At S3012, a check is performed for completion of the migration for the S-VOL and P-VOL from the pair of the source Primary/Secondary storage to the pair of the destination Primary/Secondary storage. If migration is not complete (NO), then the destination primary storage and the secondary primary storage proceed to S3005. If migration is complete (YES), then the pair of the destination Primary/Secondary storage changes state from the resync state to the asynchronous copy state. The destination primary storage stops the bitmap and starts a journal log to send host write data to the S-VOL of the destination secondary storage.

In a migration process of the flow chart, the S-VOL data continues to be used without the initial copy from the P-VOL. The initial copy from the P-VOL to the S-VOL tends to require more time than the resync using the bitmap of differential data of the P-VOL and the S-VOL, due to the long distance network and lesser throughput performance.

FIG. 31 illustrates an example environment of a non-disruptive I/O and synchronous remote copy volume migration configuration from other systems, in accordance with an example implementation. The flow and environment are similar to the asynchronous configuration of FIG. 29. The P-VOL of the source primary storage and the S-VOL of the source secondary storage contain the same data volume since they undergo synchronous remote copy operations. Both the destination primary storage and the source secondary storage mount the P-VOL from the source primary storage and the S-VOL from the source secondary storage respectively. Then, the host path is changed based on the flow as described in FIG. 12. Both the destination primary/secondary storages migrate data from the source primary/secondary storages respectively. When the destination primary storage receive the host write I/O, then the destination primary storage writes both to the P-VOL of the source and the destination primary storage, and the destination primary storage sends the host write data to the S-VOL. When the destination secondary storage receives the synchronous remote copy data, then the destination secondary storage does not write to the S-VOL of the source secondary storage due to the synchronous remote copy operation between the source primary storage and the source secondary storage.

FIG. 32 illustrates an example flow chart 3200 for changing the configuration of the volume ID, in accordance with an example implementation. In the flow diagram of FIG. 32, the migration volume is changed from the volume ID of the source storage ID to the volume ID of the destination vendor Organizationally Unique Identifier (OUI) ID.

At S3201, The destination secondary volume ID is changed from the volume ID of the source storage ID to the volume ID of the destination vendor OUI ID, and the secondary server mount configuration is changed. At S3202, the primary site is placed under maintenance and the secondary site is boot up. At S3203, the destination primary volume ID is changed from the volume ID of the source storage ID to the volume ID of the destination vendor OUI ID, and the primary server mount configuration is changed. At S3204, the secondary site is placed under maintenance and the primary site is boot up. At S3205, the source primary/secondary storages are removed. This flow thereby may provide for ID configuration changes with reduced application down time.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example implementations, the steps carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A storage system, comprising:
a plurality of storage devices; and
a controller coupled to the plurality of storage devices, and configured to:
provide access to a virtual volume for a computer, the virtual volume being mapped to a logical volume of another storage system, to manage data stored in the logical volume by using the virtual volume;
obtain path information of the another storage system, the path information comprising information identifying an active status of a first port of the another storage system targeted from the computer;
modify the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and
send the modified path information to the computer.

2. The storage system of claim 1, wherein the controller is further configured to:
conduct thin provisioning volume migration from the another storage system to the storage system, based on logical block address (LBA) status information of the another storage system.

3. The storage system of claim 1, wherein the controller is further configured to:
conduct snapshot volume migration from the another storage system to the storage system, based on at least one of logical block address (LBA) mapping information and pool block address (PBA) mapping information of the another storage system.

4. The storage system of claim 1, wherein the controller is further configured to:
conduct tier virtual volume migration from the another storage system to the storage system, based on information of the another storage system from a logical block address (LBA) access hints command.

5. The storage system of claim 1, wherein the controller is further configured to:
conduct data de-duplication volume migration from the another storage system to the storage system, based on at least one of logical block address (LBA) mapping information and pool block address (PBA) mapping information of the another storage system.

6. The storage system of claim 1, wherein the controller is further configured to:
conduct asynchronous remote copy volume migration from the another storage system to the storage system, based on a configuration to suspend remote copy operation of a primary volume of the another storage system.

7. The storage system of claim 6, wherein the controller is further configured to conduct the asynchronous remote copy volume migration from the another storage system to the storage system, based on a configuration to mount a secondary volume of the another storage system.

8. The storage system of claim 7, wherein the controller is further configured to conduct the asynchronous remote copy volume migration from the another storage system to the storage system, based on a configuration to resynchronize a primary volume of the storage system with the mounted secondary volume of the another storage system.

9. The storage system of claim 1, wherein the controller is further configured to:
conduct synchronous remote copy volume migration from the another storage system to the storage system, based on a configuration to mount a primary volume of the another storage system.

10. A computer readable storage medium storing instructions for executing a process for a storage system, the instructions comprising:
providing access to a virtual volume for a computer, the virtual volume being mapped to a logical volume of another storage system, to manage data stored in the logical volume by using the virtual volume;
obtaining path information of the another storage system, the path information comprising information identifying an active status of a first port of the another storage system targeted from the computer;
modifying the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and
sending the modified path information to the computer.

11. The computer readable storage medium of claim 10, wherein the instructions further comprise:
conducting thin provisioning volume migration from the another storage system to the storage system, based on logical block address (LBA) status information of the another storage system.

12. The computer readable storage medium of claim 10, wherein the instructions further comprise:
conducting snapshot volume migration from the another storage system to the storage system, based on at least one of logical block address (LBA) mapping information and pool block address (PBA) mapping information of the another storage system.

13. The computer readable storage medium of claim 10, wherein the instructions further comprise:
conducting tier virtual volume migration from the another storage system to the storage system, based on information of the another storage system from a logical block address (LBA) access hints command.

14. The computer readable storage medium of claim 10, wherein the instructions further comprise:
conducting data de-duplication volume migration from the another storage system to the storage system, based on at least one of logical block address (LBA) mapping information and pool block address (PBA) mapping information of the another storage system.

15. The computer readable storage medium of claim 10, wherein the instructions further comprise:
conducting asynchronous remote copy volume migration from the another storage system to the storage system, based on a configuration to suspend remote copy operation of a primary volume of the another storage system.

16. The computer readable storage medium of claim 15, wherein the conducting the asynchronous remote copy volume migration from the another storage system to the storage system is further based on a configuration to mount a secondary volume of the another storage system.

17. The computer readable storage medium of claim 16, wherein the conducting the asynchronous remote copy volume migration from the another storage system to the storage system is further based on a configuration to resynchronize a primary volume of the storage system with the mounted secondary volume of the another storage system.

18. The computer readable storage medium of claim 10, wherein the instructions further comprise:
conducting synchronous remote copy volume migration from the another storage system to the storage system, based on a configuration to mount a primary volume of the another storage system.

19. A method for a storage system, the method comprising:
providing access to a virtual volume for a computer, the virtual volume being mapped to a logical volume of another storage system, to manage data stored in the logical volume by using the virtual volume;
obtaining path information of the another storage system, the path information comprising information identifying an active status of a first port of the another storage system targeted from the computer;
modifying the path information to form modified path information comprising information identifying an inactive status for the first port and an active status for a second port of the storage system to be targeted from the computer, such that the computer is operable to change an active path from the first port to the second port and further operable to send I/O commands to a target port via the active path; and
sending the modified path information to the computer.

20. The method of claim 19, further comprising conducting asynchronous remote copy volume migration from the another storage system to the storage system, based on a configuration to suspend remote copy operation of a primary volume of the another storage system.
